(19) United States
(12) Patent Application Publication
(10) Pub. No.: US 2022/0327570 A1
(43) Pub. Date: Oct. 13, 2022

(54) INCORPORATING ADDITIONAL BLOCKCHAINS INTO A MULTI-LEVEL MARKETING SYSTEM BLOCKCHAIN

(71) Applicant: KwikClick, LLC, Murray, UT (US)

(72) Inventor: Fred Cooper, Farmington, UT (US)

(21) Appl. No.: 17/733,705

(22) Filed: Apr. 29, 2022

Related U.S. Application Data
(63) Continuation of application No. 17/706,406, filed on Mar. 28, 2022.
(60) Provisional application No. 63/166,809, filed on Mar. 26, 2021.

(51) Int. Cl. G06Q 30/02; H04L 9/00; G06F 16/955; G06F 40/134; H04L 9/08; G06Q 30/06; G06Q 20/04

(52) U.S. Cl. CPC G06Q 30/0214; H04L 9/50; G06F 16/9558; G06F 40/134; H04L 9/08; H04L 9/006; G06Q 30/0633; G06Q 20/047

(57) ABSTRACT

The present disclosure is directed to methods that may store data securely at a set of linked data-blocks. Information that may be used to track a series of product or service purchases (transactions) may be stored in these sets of linked data-blocks to facilitate the fidelity of data associated with sets of transactions made by related users that belong to a multilevel marketing (MLM) organization. Data stored at these data-blocks may be protected by pairs of keys to mitigate data loss, data corruption, or accesses by nefarious individuals. Each data-block of this chain of data-blocks may be parsed to identify commission data and to identify users that should receive commissions based on the sale of the product or service. These data-blocks may store as a set of blockchain data where pointers point to different respective data-blocks that contain data used to identify specific users that should receive commissions.

### CROSS-REFERENCE TO RELATED APPLICATION

This application is a continuation-in-part and claims the priority benefit of U.S. patent application Ser. No. 17/706,406, filed Mar. 28, 2022, which claims the priority benefit of U.S. provisional patent application 63/166,809, filed Mar. 26, 2021, the disclosures of which are incorporated herein by reference.

### BACKGROUND OF THE INVENTION

### 1. Field of the Disclosure

The present disclosure relates to incorporating additional sets of data organized as a chain of data-blocks into existing data structures that store blockchain data used to track information associated with sales of a multilevel marketing organization. More specifically, the current disclosure is directed to compiling, processing, and transferring data sets across different blockchain systems.

### 2. Description of the Related Art

A multilevel marketing (MLM) system provides a structure for transactions conducted by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing (MLM) is a legitimate business sales strategy when a MLM organization sells physical products or services. Organizations that require new users to pay money to join and that distribute commissions based on the monies paid by new users without selling physical products or services are illegal pyramid schemes. Such pyramid schemes involve taking advantage of people by pretending to be engaged in legitimate multilevel or network marketing. Such illicit pyramid schemes may be identified by their greater focus on recruitment than on product sales. Another indicator in determining the legitimacy (or lack thereof) of a multilevel marketing company is whether it sells its products primarily to consumers or to its members who must recruit new members to buy their products. In the case of the former, the company is likely a legitimate multilevel marketer. In the case of the latter, the company could be an illegal pyramid scheme.

Although each MLM company may specify its own specific financial compensation plan for the payout of any earnings to their respective participants, the common feature that is found across all MLMs is that the compensation plans theoretically payout to participants only from two potential revenue streams. The first is paid out from commissions of sales made by the participants directly to their own retail customers. The second is paid out from commissions based upon the wholesale purchases made by other distributors below the participant who have recruited those other participants into the MLM. In the organizational hierarchy of MLMs, participants are referred to as one's downline distributors. MLM sales people (distributors) are, therefore, expected to sell products directly to end-user retail consumers by means of relationship referrals and word of mouth marketing.

Currently, in order to join an MLM, there is an initiation fee, which is a barrier against those that just wish to refer to a single product they like. Current multi-level marketing (MLM) systems do not take full advantage of the Internet and how consumers can influence other consumers to make purchases. Also, current MLM systems do not incorporate incentivizing users of a multi-level marketing system by offering a dynamic commission tree. In addition, there is no current MLM system that utilizes the money or funds dedicated to discounts or coupons to be reincorporated into a multi-level marketing system to incentivize consumers to make purchases and advertise the product that they purchased. Further, current MLMs require that you be a known member in order to distribute a product where users have no way to allow anonymous buyers to be part of a member's set of related buyers of products or services.

MLMs that begin to use blockchain technology to ensure the fidelity of data may run into problems in transporting data from one blockchain to another where the intermediate step is much more vulnerable to data loss, corruption, or outside attack than either of the two blockchains. As such, there exists a need for a system that addresses these aforementioned issues that also allows for an additional level of security to an MLM system by distributing the data about the system across multiple systems so that no single intrusion can collect all the data about users of the system. What are needed are methods and apparatus that allow data to be transferred from existing blockchains while maintaining the fidelity of different data sets.

### SUMMARY OF THE CLAIMED INVENTION

The presently claimed invention is directed to apparatus and methods that may be implemented as a non-transitory computer readable storage medium where a processor executes instructions out of a memory. In a first embodiment, a first computing system may extract data from a database that stores at least one of product data associated with a product and user data associated with a first user. Next, a first set of blockchain data may be requested from a blockchain system using the extracted data and a public key. This first set of blockchain data may be associated with one or more of the product and the first user. Access to the first set of blockchain data may require validating the public key and an associated private key. This may also include a set of processed data may be generated by processing the extracted data and the first set of blockchain data. The set of processed data may be sent to at least one of the first blockchain system, a second computing system, or a second blockchain system. The set of processed data may then be stored at a database accessible by the first computing system.

In a second embodiment, a presently claimed method may include generating, based on commission data, a public key, a corresponding private key, and a pointer that points to the private key. The private key and the commission data may then be stored at a block of a database accessible by a first computing system. Next, the pointer and the public key may be sent to a second computing system. The second computing system may be allowed to access the commission data stored at the block of the database based on the use of the pointer and the public key by the second computing system.

### BRIEF DESCRIPTION OF THE DRAWINGS

FIG. 1 illustrates a network environment wherein additional sets of blockchain data may be incorporated in to a multilevel marketing system.

FIG. 2 illustrates a series of steps that may be performed at an administration network computer of a multilevel marketing system.

FIG. 3 illustrates another series of steps that may be performed by a computer that administrations transactions associated with a multilevel marketing organization.

FIG. 4 illustrates a series of steps that may be performed when commissions associated with the sale of a product are identified and provided to users of a multilevel marketing organization.

FIG. 5 illustrates respective blocks that may be used to store commission information.

FIG. 6 illustrates a computing system that may be used to implement an embodiment of the present invention.

### DETAILED DESCRIPTION

The present disclosure is directed to methods that may store data securely at a set of linked data-blocks. Information that may be used to track a series of product or service purchases (transactions) may be stored in these sets of linked data-blocks to facilitate the fidelity of data associated with sets of transactions made by related users that belong to a multilevel marketing (MLM) organization. Data stored at these data-blocks may be protected by pairs of keys to mitigate data loss, data corruption, or accesses by nefarious individuals. Each data-block of this chain of data-blocks may be parsed to identify commission data and to identify users that should receive commissions based on the sale of the product or service. These data-blocks may be stored as a set of blockchain data where pointers point to different respective data-blocks that contain data used to identify specific users that should receive commissions.

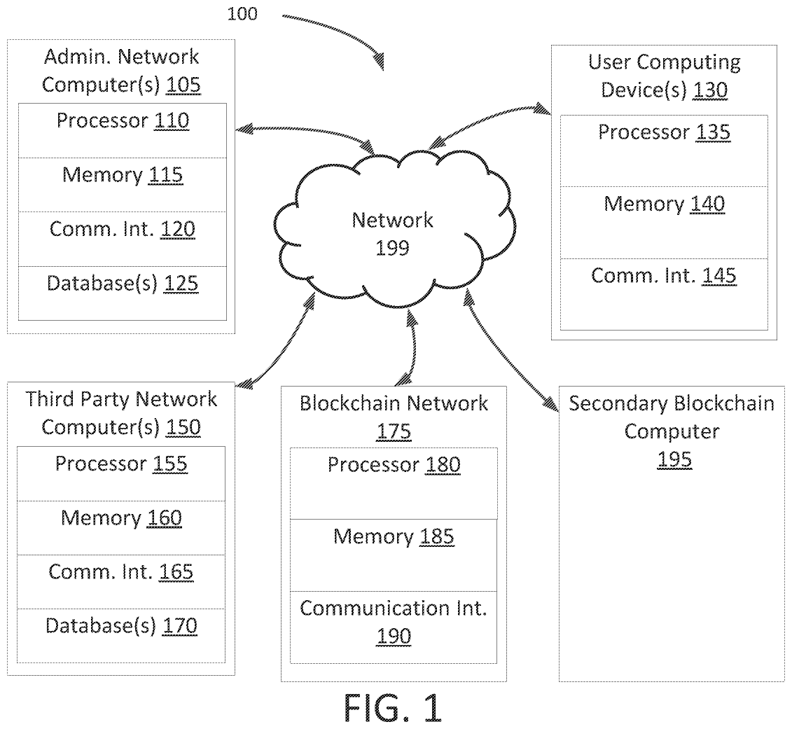

FIG. 1 illustrates a network environment wherein additional sets of blockchain data may be incorporated in to a multilevel marketing system. FIG. 1 includes administration network computer(s) 105, third party network computer(s) 150, user computing devices 130, bloackchain network 175, and secondary blockchain 195 that communicate via network 199. Each of the devices that communicate via network 199 may include their own memory and processor that executes instructions out of their respective memory. Administration network computer 105 includes processor 110, memory 115, communication interface 120, and database(s) 125. User computing device(s) 130 includes processor 135, memory 140, and communication interface 145. Third party network computer(s) include processor 155, memory 160, communication interface 165, and database(s) 170. A blockchain network 175 computer includes processor 180, memory 185, and communication interface 190. While not shown in FIG. 1, secondary blockchain 195 may also include a processor and a memory that performs functions associated with a secondary blockchain 195 network. In certain instances, data relating to sales of an MLM organization may be stored at the blockchain network 175 computer and at the secondary blockchain 195 computer of FIG. 1. Methods of the present disclosure may evaluate data stored at different blockchain network computers to validate that data stored at respective blockchain network computer are consistent and accurate.

Program code stored in memory 115 of administration network computer 105 may include different sets of instructions organized in different software modules. These different software modules may include an administration network module, an administration network base module, an administration network calculation module, an administration network commission module, an administration network advertising module, and an administration network vendor module. Databases 125 of FIG. 1 may include an administration network administration database, an administration network compensation database, and an administration network hyperlink database.

Distributors of a multilevel marketing (MLM) organization may refer to participants of a non-salaried workforce selling the company's products or services, while the earnings of the participants are derived from a pyramid-shaped or binary compensation commission system. A product may refer to an article or substance that is manufactured or refined for sale, and a service may refer to a system supplying a public need such as transport, communications, or utilities such as electricity or water. A service may be an act of dealing with a customer in a store, restaurant, or hotel by taking their orders, showing, or selling them goods. Additionally, a service may be work that someone does or time that someone spends working for an organization or a business that offers a particular type of help or work.

In some instances, an MLM tree or commission tree may refer to the payment structure in which commissions are given out. An MLM system may belong to a marketing organization that relies on person-to-person sales by independent representatives that may work from home. A network marketing business may require independent representatives to build a network of business partners or salespeople to assist with lead generation and sale closings. An end of life of the MLM tree may refer to the number of levels after which further distributors in a particular MLM tree will not receive commissions relating to a purchase. At such a point, a new commission tree may start up again. For example, when a tree of related users includes more than four related users, commissions may only be paid to the first four related users.

An existing MLM system may refer to currently existing or established companies that use the sales strategies to encourage existing distributors to recruit new distributors who are paid a percentage of their recruits' sales. The administration network computer 105 may be protected by data security and an MLM algorithm that allows devices to connect to an application store. Here, data security may refer to the process of protecting data from unauthorized access and data corruption throughout its lifecycle. Data security may include data encryption, tokenization, and key management practices that protect data across all applications and platforms. The MLM algorithm may refer to the calculation performed using the compensation decay rate in order to calculate the commissions for downline participants. Downline participants may be distributors of particular products that were sponsored by other “upline” distributors of those particular products. The term “connect app store” may refer to a process with a computing device connects an application store to an MLM system.

Administration network computer 105 may connect to a third party network computer 150 when a product is enrolled for sale by distributors of an MLM organization. When a user wishes to enroll a new product to be sold by members of an MLM organization, a user may identify a product or provide data from which a product identifier may be identified. A product identifier (ID) may be a alphanumeric string of characters uniquely associated with a product. This user may also identify a link to a web page that provides product information. Such a web page may be hosted by a computer of a third party, such as the third party network computer 150 of FIG. 1. This web page may be referred to as a landing page to which users may be directed to when they select a link or hyperlink. A landing page may be pointed to using a universal resource locator (URL), such as www.homedepot.com/drill654123. In certain instances, the third party network computer 150 or an administration network computer 105 may identify whether the product ID is currently enrolled as a product being sold by users of the MLM organization. When the product ID has already been enrolled, the user may start a new chain of related users and be allowed to sell the product to other users. In such an instance, this user may be a first user in a new tree or set of related users that sell the product after this user purchases the product. At this time, other sets of related users that have sold or that have purchased the product may be tracked via a respective set of user tracking data. Tracking data may be stored as a set of blocks that point to each other forming a chain of blocks (i.e. a blockchain). In contrast, when a given product ID is not currently enrolled with an MLM organization, a user may become a first user to offer the product for sale via the MLM organization. In either case, information associated with the product (e.g. product ID and/or landing page URL) may be included in a new set of tracking or blockchain data.

Distributors of the MLM organization may receive data regarding product sales or offerings via user device 130. When an order is processed, administration network computer 105 may receive data from third party network computer 150 that allow discounts to be identified and then calculations may be performed to identify commissions that should be paid to upline distributors when a product is sold. Processor 110 of administration network computer 105 may perform these calculations based on a commission schedule/plan that includes a commission decay rate. Distributors of a product that are farther from this sale may receive lower commissions based on a decay rate. Here, a decay rate may be a rate at which respective related users, where users that are “farther” from a current sale of a product receive lower commissions as compared to users that are “closer” to the current product sale. This process may include the administration network computer 105 accessing a computer of blockchain network 175 such that the administration network computer 105 can track sales and related commissions.

A commission may refer to a payment to someone who sells goods that are directly related to a sale or chain of sales of a product. In certain instances, particular distributors may only receive commissions when those distributors previously purchased the product and recruited others to purchase that same product. A compensation plan or a commission schedule may include a decay rate of the commissions provided to distributors (i.e. related users) of the MLM organization. In certain instances, purchasers may receive discounts that motivate those users to purchase a particular product. Administration network computer 105 may continuously poll third party network computer 150 for sales relating to a particular product or may receive data from third party network computer 150 when an MLM related product sale is processed. Administration network computer 105 may also access data stored at a computer of blockchain network 175 when distributing commissions.

An upline may refer to the MLM distributors that recruit salespeople to sell products or services, while a downline may refer individual users that have been recruited to participate in a MLM organization by an upline user. Downline trees may refer to data that links upline user distributors to downline user distributors of a particular product. In certain instances, such downline trees may cross country boundaries and commissions may be paid out to distributors that reside anywhere in the world. Users of the present system are not relegated to always be downline of a user that sponsored them to sell a given product. For example, in an instance when a first user sponsored a second user to purchase a drill product, the second user would be downline of the first user for sales of the drill product associated with the second user. Here the second user could be upline of the first user for sales of a bicycle product in an instance when the second user sponsors the first user to purchase the bicycle product.

Commissions may be paid out users in any currency they desire. A contact list may be accessed in order to cross-reference a user's potential downline purchasers/distributors with a link, such as a hyperlink, and a code for the potential downline purchasers/distributors to become part of a particular MLM tree.

An administration network database 125 may store data that was received from a third party network computer 150. This data may identify a seller and a product. A product may be identified with an item identifier (ID). Other data that may be stored may include a description of an item, an original cost of the item, a discount for the item, a resulting cost of the item, and/or a pointer that points to a compensation schedule (e.g. a compensation decay rate). In certain instances, at least some of this information may have been received from third party network computer 150 after a product was enrolled in the MLM organization or after an MLM related sale of the product was processed by third party network computer 150.

Data may be stored at network compensation database 125 may include referral hyperlinks and enrolled product data. A set of program code may allow processor 110 to create hyperlinks by combining a user-specific referral code with the product-specific landing page information (e.g. a URL that points to a product). Click-throughs of any hyperlinks may be tracked to obtain the referral code that is included in the hyperlink. This may result in a new entry being stored at database 125 that cross-references item IDs, user IDs, parent codes, child codes, or other information. Data that identifies a landing page may also be stored at database 125, and this information may identify item IDs and a URL that links to a webpage where the product can be purchased. A code in the hyperlink that a person clicks on may include or be associated with a parent code for a particular blockchain entry. Once the person that clicked on the hyperlink buys the product, a second code may be associated with that person and the sale of that product to that person. This second code may be referred to as a child code. Sets of blockchain data may associate parent codes with child codes from which relationships between respective users may be identified. A parent code may be associated with or identify a first user distributor that sponsored a second user to purchase the product and the child code may be associated with the second user.

The code associated with the second user may then be considered a parent code when the second user begins to sell the product. In an instance when the second user provides marketing materials to a third user and after the third user buys the product, the third user may be assigned a child code and the third user may then become a distributor of the product. A rule for becoming a distributor of the MLM organization for a given product may require that a respective user purchase the product before they can sell the product to others.

Communication network 199 of FIG. 1 may be a wired and/or a wireless network that provides access to or through the Internet. Communication network 199 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art, or any combination thereof in various possible embodiments. The communication network 199 may allow ubiquitous access to shared pools of configurable system resources and higher-level services that can be rapidly provisioned with minimal management effort.

User (e.g., product purchasers/distributors) device 130 may be an electronic device such as a laptop, smartphone, tablet, computer, smart speaker, or the like. User device 130 may connect to the third party network computer 150 after a user selects a hyperlink received by user device 130. A determination may be made to identify whether the user entered a code or whether a code was included in the hyperlink is selected by (clicked on) a user of user device 130. In such an instance the link and code may be provided to the third party network computer 150 automatically.

User data and follower data as well as a follower's contact information may be stored at or may be accessed by the administration network computer 105 such that commissions may be paid based on product purchases. In some instances, a distributor contact list or follower list may refer to the recruits or followers of a user on social media site. A database that stores user information may identify ratings and recommendations received from particular users.

Third parties may be entities such as retail stores that sell products, consumables, or services. Third parties may be franchises, service networks, large box stores, or e-commerce sites. A third party computer 150 may store data relating to an e-commerce shopping cart that offers items to users at a discount. A franchise may refer to an authorization granted by a government or company to an individual or group enabling them to carry out specified commercial activities (e.g., providing a broadcasting service, or acting as an agent for a company's products). In some instances, product consumables may refer to goods used by individuals and businesses that must be replaced regularly because they wear out or are used up. Service networks may refer to a collection of people and information brought together on the internet to provide a specific service or achieve a common business objective, such as Angie's List.

An E-commerce sale may refer to sales of goods and services where the business takes place over the internet, an extra-net, an electronic data interchange (EDI), other online system, or any combination thereof. Payments may or may not be made online. An e-commerce shopping cart may refer to software used in E-commerce to assist visitors to make purchases online. Upon checkout, the software may allow a processor to calculate the total of an order, including shipping and handling fees, taxes, and other costs or fees. A retailer may refer to a person or business that sells goods to the public in relatively small quantities for use or consumption rather than for resale. Product discounts may refer to a reduced price for something being sold at a price lower than that item is normally sold for. As such a discount may be a reduction to a basic price for a good or service. Large box stores may refer to a physically large retail establishment, usually, part of a chain of stores that offers a variety of products to its customers. The term sometimes refers, by extension, to the company that operates the store, and may be referenced as a supercenter, superstore, megastore, etc.

Third party network computer 150 may continuously poll for user selections or user devices may access webpages of third party network computer 150 after a user selects a hyperlink that allows the user to purchase a product. Such selections may direct user device 130 to a webpage of a third party and may allow discounts to be applied to a product purchase.

Computers of a blockchain network 175 may manage data stored as part of a distributed network. A computer of blockchain network 175 may monitor for read or write requests being sent to the blockchain network 175, and may store commission data paid or other data based on purchased made via third party network computer 150. A blockchain network computer 175 may create public and private keys associated with data each block such that commissions may be securely distributed. The blockchain network computer 175 may create a pointer that points to a block that is provided to the administration network computer 105 such that the administration network computer 105 may access commission schedule data. This may increase security based on that fact that administration network computer 105 would not be required to persistently store this data. Such a blockchain database may store pointers to each block associated with each private key and may store commission data associated with each completed transaction. Secondary blockchain computer 195 may work in a manner similar to blockchain network 175 computer, where different blockchain network computers may store different sets of sales related data that may be combined or validated at a point in time.

Stored data may include pointers may identify parent-child relationships for a chain of blocks when a branching tree of related blockchain data sets are created. Such pointers may be associated with a number of transactions in each set of related users (i.e. in a sphere of influence of related users) of the MLM organizations. Each new product enrolled by at a third party network computer 150 may result in a new tree or new chain of related users being created. A purchase of a newly enrolled product (i.e. an initial transaction) may start a new chain of blocks. This chain of blocks may initially include a first block and this first block may be linked to other data-blocks when users downline of the first user purchases the product. These downline users may have received marketing materials from the first user. A chain of blocks may include many branches that where each branch may correspond to a particular level. Here the first user may be located at a first level and individuals that the first user recruits to purchase the product may be located at a second level. This second level may include any number of individuals that may each in turn recruit additional users to purchase the product. Each user that signs up or that participates in recruiting other users may become a distributor of an MLM organization that sells the product. Individuals that are recruited by the individuals located at the second level will be at a third level of the chain of blocks. User's located at the various different levels that are part of the chain of blocks may be considered part of the same sphere of influence, where individuals that are directly linked to each other may receive commissions based on new sales of the product.

A set of software that tracks individuals that are linked by the chain of blocks may be referred to as a blockchain network notary software module where a processor executing instructions of this notary software module may act as a gateway that is responsible for reading information on the blockchain network 175 and secondary blockchain computer 195 and may route cross-chain transactions as required. Data from the secondary blockchain computer 195 may be stored and verified on the blockchain network 175. A set of blockchain network notary nodes may be computers at blockchain network 175 that execute instructions of a blockchain verification protocol in order to verify that any given transaction within the secondary blockchain computer 195 is verified and/or confirmed. Information identifying that this verification and/or confirmation may be provided to other computers of blockchain network 175. Secondary blockchain computer 195 may store any digital record that utilizes the foreminded blockchain protocol, a derivative protocol, or any combination thereof.

Functions associated with performing calculations may include extracting discount information from a database 125 of the administration network computer. This discount information may be been identified from information received from the third party network computer 150 and this data may be stored at database 125 of the administration network computer 105. A pointer associated with the identified product may be used to send a request to the blockchain network 175 to identify compensation (commission) schedules and/or commission decay rates that have been paid or should be paid to specific users.

When a product is purchased, related commissions may be calculated by applying a discount on the item such that it may provide 50% of the discount to the first participant, and the remaining amount of the discount for the downline users at a 50% decay rate. For example, if the first user purchased an item that was originally $59.00 discounted by 15%, the first user to make the purchase would receive $3.32 or 50% of the discount. Any follower of the user who made the initial purchase would receive 50% of the remaining discount or 50% of $3.32, and this may continue until there is only one cent left to pay out as a commission for the downline users.

When commissions are processed, the administration network computer 105 may send data to computers of the blockchain network 175 and this data may be written to a next block of a blockchain that is related to a recent purchase of an item. This blockchain data may be stored at one or more computer of or accessible via blockchain network 175. The administration network computer may receive data that includes or that is associated with a code and a hyperlink that points to offering for the product.

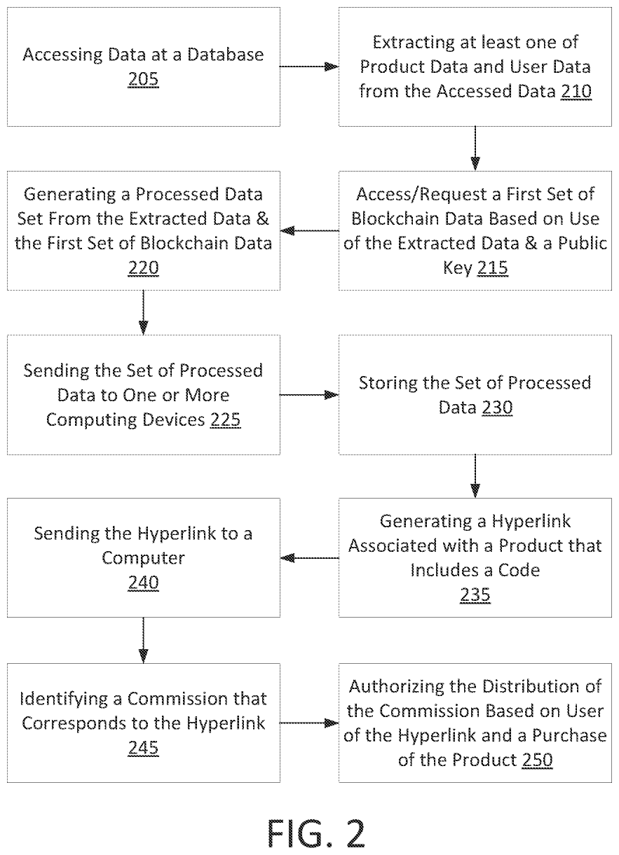

FIG. 2 illustrates a series of steps that may be performed at an administration network computer of a multilevel marketing system. These steps may process data associated with products purchased via an MLM organization. The steps of FIG. 2 may be performed such that users may order products, where orders for those products may be received or fulfilled by operators of the third party network computer 150 of FIG. 1. FIG. 2 begins with step 205 where data is accessed at a database. This database data may include product data and user data. This data may associate a product described by the product data with a chain of related users of a multilevel marketing (MLM) organization. As discussed above, a first user may be a user that first registered a product to be sold via an MLM organization or the first user may have become a distributor of the product after purchasing the product. The first user may have provided advertising information to a second user and this advertising information may include a hyperlink that includes information identifying a user ID of the first user and may this hyperlink may include a link that points to a web page or “landing page” of the product hosted by a third party third party computer 150 of FIG. 1. In an instance when the second user enters the code or selects the hyperlink, a computing device of the second user may be directed to the product landing page. Step 205 may have been performed after the second user purchases the product.

Next in step 210, the product data, user data, or both may be extracted from the database data accessed in step 205. The administration network computer may then cross-reference the extracted information when identifying a public key and a pointer that points to a first set of blockchain data. This first set of blockchain data may be accessed in step 215 using the public key and the pointer. After step 215, a processed data set may be generated from the extracted data and from data included in the first set of blockchain data. This set of processed data may be sent to one or more computing devices in step 225 and the processed data may be stored in step 230 of FIG. 2. Access to the blockchain data may be allowed after a computer of blockchain network 175 validates the public key based on an association with a private key stored at the blockchain network 175 computer.

Next at step 235, a new hyperlink may be generated that includes a link to the product landing page (e.g. a URL) and a code associated with the second user. This new code may be a child code that is associated with a parent code of the first user. Data may then be sent to another computer, for example the blockchain network computer 175, at step 240 of FIG. 2. Data stored at the blockchain network 175 computer may be updated to include a new data-block of blockchain data that links the second user to the first user. The administration network computer 205 may then identify commissions that correspond to the hyperlink in step 245 and those commissions may be distributed to users in step 250 after the user that selected the hyperlink purchases the product.

When a hyperlink is generated, a product ID may be checked to see whether a product is already being sold by members of the MLM organization. A link, such as a universal resource locator (URL) that points to a landing page may be identified and the hyperlink may be created. This hyperlink may include the URL and user parent and/or child codes. Marketing material that includes this hyperlink may be sent to a user and after that user selects the hyperlink, a cookie may be downloaded on to a user device such that activities of that user device may be tracked. The URL may be extracted at from the hyperlink and the user device may be directed to a web page pointed to by the URL.

In certain instances, an administration network computer may host its own domain name service (DNS) server, and the URL contained in the hyperlink may be directed to this DNS server in order to identify an IP address of the web page and program code that tracks user actions may be initiated. The URL in the hyperlink may direct a browser of the user device to a web page, which may in turn may redirect the browser to a landing page. When the hyperlink includes a child code data that child code may sent to the set of tracking program code. The child code may be read and an item ID may be identified from the URL in the hyperlink. A processor executing instructions of this tracking code may create a new entry in a hyperlink database and the child code may be stored as a parent code for this new database entry. When a product is purchased using this new parent code another new child code may be generated, for example, by using a random string generator. The generated string should be long enough that the chance of a string being generated twice is effectively zero. In some instances, a computer may check to make sure no identical code exists in the hyperlink database. In other instances, the child code may be mathematically created from the parent code in a way that makes it unique. The newly generated child code may be stored at the hyperlink database. A user of the user device may then be prompted to enter their user ID by way of a pop-up window or a tab in their browser. Alternatively or additionally, the user may be identified via their IP address or MAC address of their computer. In other instances, a third party site may prompt the user for their user ID after a purchase is made. A browser-based add-on may automatically inform the processor executing the tracking instructions of the user's ID. In other instances, a user ID may be randomly generated and later assigned to a user who is involved with a transaction (e.g., by scanning a receipt). At this point, the user ID may be stored with the data of the hyperlink database.

Table 1 table displays data that may be stored at the administration database 125 of FIG. 1. When the administration network computer 105 receives item data from third party network computer 150 it creates a link for the item, stores the received data in the administration network administration database 125, and sends the created link back to the third party network computer 150. The administration network database 125 may be used to store data collected from various third parties that enrolled in the multi-level marketing system 100 of FIG. 1. The administration network database 125 may store the name of the third party, the ID for an item, a description of the item, the original cost of the item, the discount provided by the third party, the cost of the item with the discount, and the link to the item. Alternatively, or additionally this data may be stored at a computer of the blockchain network 175 or at the secondary blockchain computer 195. A compensation decay rate or schedule may be identified based on a pointer, such as pointer 654123-Point1 that points to a compensation decay rate associated with a given product that may be stored at a blockchain database. The compensation decay rate data may not be persistently stored at the administration network database 125 and instead only be accessible when needed.

TABLE 1
Administration Database Data

| | | | | |
|---|---|---|---|---|
| Third Party | Home Depot | Home Depot | Furniture | Pharmacy |
| | | | Store | |
| ID | 654123 | 789654 | 123789 | 456812 |
| Item | Drill | Table Saw | Couch | Cold |
| | | | | Medicine |
| Original Cost | $59.00 | $119.00 | $999.00 | $25.00 |
| Discount | 0.15 | 0.1 | 0.1 | 0.05 |
| Discount | 50.15 | 107.1 | 899.1 | 23.75 |
| Cost | | | | |
| Pointer | 654123- | 654123- | 654123- | 654123- |
| | Point1 | Point2 | Point3 | Point4 |

The administration database 125 may store data that the administration network computer 105. This data may be accessed when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media, and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

Table 2 illustrates exemplary sets of compensation data that may be stored at a database accessible by administration network computer 105 of FIG. 1. Processor 110 of the administration network computer 105 of FIG. 1 may receive compensation data from blockchain network computer 175 securely upon request. This may include the use of both a private key stored at the administration network computer 110 and may include a public key that the administration computer sends to the blockchain network computer 175. Commission data sent to the administration network computer may be encoded using the public key and may be decoded by the administration network computer using the private key. Decay rates and top level (a highest commission or “topline” commission) commission data received from the blockchain network computer 175. This may allow processor 110 to calculate the commissions that should be paid to related users based on a sphere of influence of users. This may include accessing data stored at a database of blockchain network 175 or at the secondary blockchain computer 195.

Table 2 cross-references sales of a cold medicine that has product identifier of 456812 sold by third (3^{rd}) party vendor Vons. Table 2 also cross-references different spheres of influence with specific pointers and specific codes or links. The data of table 2 may be associated with purchases of a same type of cold medicine (456812) by a first, a second, a third, and a fourth user where each of these user are associated with a different sphere of influence. Here a first user may have recommended the cold medicine to the second user, the second user may have recommended this cold medicine to the third user, and the third user may have recommended the cold medicine to the fourth user. Each of these respective users may be associated with a chain of users and different spheres of influence and commissions may be paid out according to the compensation decay rate when a downline user purchases the cold medicine. Here users closest to a user that purchases the product may receive a largest commission.

Commissions paid out to respective users may calculated based on data stored at a blockchain database. This blockchain database may also store commissions paid to respective users. Here a pointer to the commission paid for each sphere of influence level and the code may be used by the user's followers to enroll in the MLM system. These codes or links may be unique and may identify a single user. These codes may be used to identify specific users that purchase specific products and may be used to identify other users that should receive commissions when the cold medicine is purchased.

TABLE 2
Compensation Database Data

| | | | | |
|---|---|---|---|---|
| Third | Vons | Vons | Vons | Vons |
| Party | | | | |
| ID | 456812 | 456812 | 456812 | 456812 |
| Item | Cold | Cold | Cold | Cold |
| | Medicine | Medicine | Medicine | Medicine |
| Sphere of | First | Second | Third | Fourth |
| Influence | | | | |
| Level | | | | |
| Pointer | 456812- | 456812- | 456812- | 456812- |
| | Point1 | Point2 | Point3 | Point4 |
| Code/Link | 456812- | 456812- | 456812- | 456812- |
| | SOI2 | SOI2 | SOI3 | SOI4 |

In some instances, the compensation database data may include a lottery structure for how the commissions are paid to users or freelancers. Such a lottery may refer to a process or things whose success or outcome is governed by chance. A means of raising money by selling number tickets and giving prizes to the holders of numbers drawn at random. Here, freelancers may refer to a person who works as a writer, designer, performer, contractor, or the like. Such freelancers may sell work or services by the hour, by the day, by the job, etc., rather than working on a regular salary basis for one employer.

Table 3 illustrates a set of data referred to herein as “landing page” data. This data cross-references an item identifier (ID) with an item name, a vendor (e.g. a 3^{rd} party vendor), and a universal resource locator that points to a website of the vendor where an item (e.g. a product or service) is offered for sale. This landing page data may be stored in a landing page database or may be stored as landing page data stored at a database that stores various different types of data accessible by an administration network computer, such as database 125 of administration computer 105 of FIG. 1. Alternatively, this data may be stored at a database of a third party vendor accessible by the administration network computer. This landing page data may be accessible by software modules executable at an administration computer when the administration computer performs tasks of selling products and services offered via participation in an MLM organization. Table 3 identifies that item id 654123 is associated with an item named “drill” product sold by a third party vendor Home Depot at URL https://www.homedepot.com/ . . . Table 3 also cross-references item ID 789654 with a “table saw” product also offered for sale via a Home Depot URL; cross-references item ID of 123789 with a “couch” sold by vendor “Furniture Store” at URL https://www.bobsfurniture.com/ . . . ; and cross-references item ID 456812 with “cold medicine” product offered by a “pharmacy” at URL https://www.vons.com/ . . .

TABLE 3
Landing Page Data

| | | 3rd Party | |
|---|---|---|---|
| Item Id | Item Name | Vendor | Landing Page URL |
| 654123 | Drill | Home Depot | https://www.homedepot.com/. . . |
| 789654 | Table Saw | Home Depot | https://www.homedepot.com/. . . |
| 123789 | Couch | Furniture | https://www.bobsfurniture.com/. . . |
| | | Store | |
| 456812 | Cold | Pharmacy | https://www.vons.com/. . . |
| | Medicine | | |

Table 4 illustrates an exemplary set of data that may be used to track the activities of products sold by various individual distributors. A first row of table 4 includes a series of column headers that are used to cross reference item identifying numbers (IDs), product names, parent codes, child codes, user identifiers (IDs), and specific generated hyperlinks (URLs). Note that the rows 2-4 of table 4 include information that identifies sales of a type of cold medicine. First of all, a user with user ID “Kwik” purchased cold medicine with item ID of 456812. This first user is associated with child code ai9ufy6HE4. Since this first user was a first user of a new user product tree selling cold medication with item ID 456812, no parent code is associated with this purchase. The hyperlink in the second row of table 4 identifies an administration computer “Kwik,” a third party seller/store of “Vons,” product ID 456812, and child code ai9ufy6HE4.

The hyperlink in the third row of table 4 may have been provided to a user device belonging to a prospective buyer of the cold medicine assigned item ID 456812. The user device of this prospective buyer may have received marketing materials prepared by the user assigned with user ID “Kwik.” Later when this prospective buyer purchases the cold medicine, this prospective buyer may be assigned user ID HF4875 and child code LmPwRESpH. Since this prospective buyer in now an actual buyer, they may be considered a new member of a multilevel marketing tree associated with parent ID ai9Ufy6He4 (that belongs to user ID “Kwik”). Based on this chain of events, a person with user ID “Kwik” may receive a commission based on the sale of the cold medicine to a person with user ID HF4875.

The data stored in the third row of table 4 is a record of a chain of sales. This third row of data indicates that the person assigned user ID HF4875 purchased cold medicine 456812 based on a referral made using code ai9ufy6HE4. The parent code included in this third row being the same as the child code of the second row of table 4 may be used to identify which users should receive commissions for sales that they sponsored. Note also that the hyperlink included in the third row of table 4 identifies the “Kwik” administration computer, the “Vons” third party seller, the cold medicine product name, the cold medicine product ID, and the child code LMPwRESpH. In an instance when this hyperlink is used to sell the cold medicine with product ID 456812 to another new user, users associated with user ID HF4875 and user ID Kwik may each receive commissions based on this new sale.

Table 4 also tracks the sale of other products associated with other item IDs, parent codes, child codes, user IDs, and hyperlinks. Parsing of this information may be done to identify particular users that have or that should receive commissions. Note that the user with code sZa2q6jDuo is credited with selling couch 123789 to buyers with child codes IvOdgpFsJ5 and ogV1LAwT50. Note also that the buyer with child code IvOdgpFsJ5 does not have a user ID based on the not applicable/available (N/A) identifier being listed as a user ID.

Note also that the user with user ID Kwik purchased table saw 789654, that a buyer with child code g05HfVMC purchased this same type of table saw, and that the buyer with child code gO5HfVMC is also associated with selling that same type of table saw to the user with user ID VY0093 and child code z4jjna7t3c.

Each of the upline distributors/users may receive commissions identified based on parsing of respective child codes, related parent codes, and item identifier codes. For example, a user assigned user ID Kwik may receive commissions for the cold medicine purchased by users associated with both user ID HF4875 and YD9483 and a user associated with user ID HF4875 may receive a commission based on the user associated with user ID YD9483 purchasing the cold medication. Here again, commissions further from the actual purchase may be reduced or paid out based on a commission schedule.

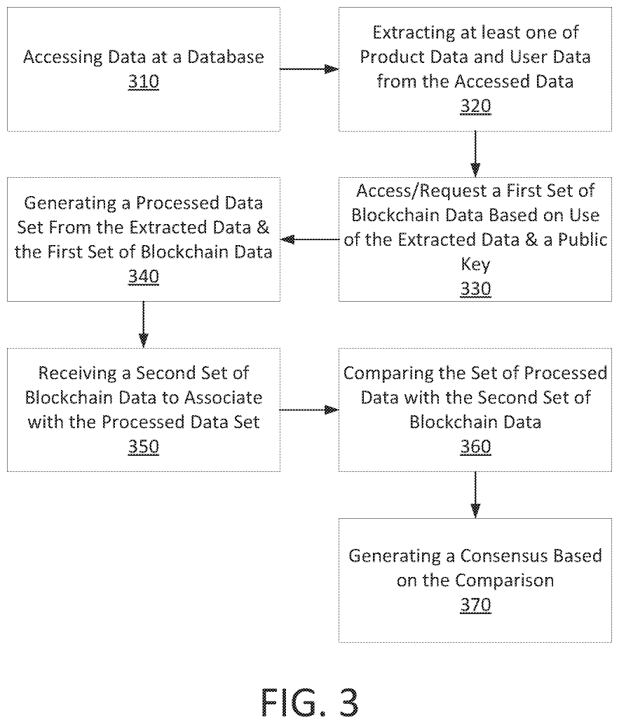

FIG. 3 illustrates another series of steps that may be performed by a computer that administrations transactions associated with a multilevel marketing organization. Note that steps 310, 320, 330, and step 340 perform the same types of operations as steps 210, 220, 230, and 240 discussed in respect to FIG. 2. Steps 310 through 340 may include accessing database data (step 310), extracting product data and user data from the accessed data (step 320), access the first set of blockchain data (step 330), and generating a first set of processed data (step 340). Next, a second set of blockchain data may be identified to associate with the set of processed data in step 350 and information included in the set of processed data may be compared with information included in the second set of blockchain data in step 360.

Step 370 may perform an evaluation that identifies whether the second set of blockchain data is valid or is consistent with requirements of an MLM organization. Step 370 may be referred to as generating a consensus between different sets of blockchain data. This consensus may be generated by compute nodes that act as a notary that validate consistency of different sets of blockchain data. A computer may include sets of notary software program instructions or software modules. The execution of a set of blockchain network notary module instructions may allow a processor to identify whether there is a consensus among different blockchain network notary nodes. This consensus may be generated by accessing either in a particular data-block or a set of data-blocks as a whole. Such a consensus may be an agreement between more than 50% of all blockchain network notary nodes, two-thirds of all blockchain network notary nodes, or some other threshold based a required level of fidelity. A Byzantine fault tolerance (BFT) algorithm may be used for notary services, but other algorithms, such as RAFT, Istanbul BFT, Simplified BFT, Redundant BFT, Crash Fault Tolerant, any other algorithm, or any combination of algorithms may be used in various possible embodiments. When there is a consensus, a blockchain network notary computer may record verified blocks or blocks of data in the blockchain network. This may occur simultaneously on one or more nodes within a blockchain network. Once verified data blocks or entrie sets of blockchain data may be copied or moved to another blockchain computer.

TABLE 4
Administration Network Hyperlink/Tracking Database Data

| | Product | | | | |
|---|---|---|---|---|---|
| Item ID | Name | Parent Code | Child Code | User ID | Hyperlink |
| 456812 | Cold | N/A | ai9ufy6HE4 | Kwik | https://kwik.vons.com/pharmacy/coldmedicine/ |
| | Medicine | | | | ?kwikcode=456812ai9ufy6HE4 |
| 456812 | Cold | ai9ufy6He4 | LmPwRESpH | HF4875 | https://kwik.vons.com/pharmacy/coldmedicine/ |
| | Medicine | | | | ?kwikcode=456812LmPwRESpH |
| 456812 | Cold | LmPwRmESpH | H23s123Dxx | YD9483 | https://kwik.vons.com/pharmacy/coldmedicine/ |
| | Medicine | | | | ?kwikcode=456812H23s123Dxx |
| 123789 | Couch | N/A | sZa2q6jDuo | Kwik | https://kwik.bobsfurnature.com/. . ./ |
| | | | | | ?kwikcode=123789sZa2q6Duo |
| 123789 | Couch | sZa2q6jDuo | IvOdgpFsJ5 | N/A | https://kwik.bobsfurniture.com/. . ./ |
| | | | | | ?kwikcode=123789IvOdgpFsJ5 |
| 123789 | Couch | sZa2q6jDuo | ogV1LAwT50 | MF1192 | https://kwik.bobsfurniture.com/. . ./ |
| | | | | | ?kwikcode=123789ogV1LAwT50 |
| 654123 | Drill | N/A | eyySAh0ijh | Kwik | https://kwik.homedepot.com/. . ./ |
| | | | | | ?kwikcode=654123eyySAh0ijh |
| 654123 | Drill | eyySAh0ijh | D5Tn6nQq70 | HG9873 | https://kwik.homedepot.com/. . ./ |
| | | | | | ?kwikcode=654123D5Tn6nQq70 |
| 654123 | Drill | N/A | EejbIOK3Uu | JD4483 | https://kwik.homedepot.com/. . ./ |
| | | | | | ?kwikcode=654123EejbIOK3Uu |
| 789654 | Table | N/A | WLW2AaMQ6Q | Kwik | https://kwik.homedepot.com/. . ./ |
| | Saw | | | | ?kwik.code=789654WLW2AaMQ6Q |
| 789654 | Table | WLW2AaM6Q | g05HfVMC | N/A | https://kwik.homedepot.com/. . ./ |
| | Saw | | | | ?kwikcode=789654g05HfVMC |
| 789654 | Table | g05HfVMC | z4jjna7t3c | VY0093 | https://kwik.homedepot.com/. . ./ |
| | Saw | | | | ?kwikcode=789654z4jjna7t3c |

Table 5 illustrates data that may be stored in a database that identifies specific private keys that are pointed to by specific pointers. The data of table 5 may be stored at a private key database and possibly at a database of a blockchain computer. Note that the pointers of table 5 include pointers 456812-Point1, 456812-Point2, 456812-Point3, 456812-Point4, 456812-Point5, 456812-Point6, and 456812-Point7. Note also that each of these different pointers include different unique private keys. This pointer and private key database data allows a blockchain network computer to provide its own level of security, separate from any security that may be performed by an administration network computer. Because of this, the use of an administration network computer and a blockchain network computer provide two levels of security that demand that an intruder would need to get past both security protocols of the administration network computer and the blockchain network computer in order to access commission information stored at databases accessible by the blockchain network computer. Security protocols implemented at an administration network computer (i.e. computer 105 of FIG. 1) could be used to secure data that identifies specific users and security protocols implemented at a blockchain network computer (i.e. computer 175 of FIG. 1) could be used to secure private keys, commission data, and possibly other product or sales data.

Table 5 also includes data that identifies a chain of commission levels that may be paid to related users when a downline user purchases a product. The number 456812 as shown in table 1 may identify a product of a cold medicine that has a commission decay rate of 50%. The pointer 456812-Point1 may be associated with a first user that purchased cold medicine 456812 and that promoted the sale of that cold medicine to a second user associated with pointer 456812-Point2, who in turn purchased the cold medicine and promoted the sale of the cold medicine to a third user associated with pointer 456812-Point3. Each subsequent user associated with each subsequent pointer may have received promotional materials to buy cold medicine 456812, may have bought the cold medicine, and may have passed promotional materials to other users who also bought the cold medicine 456812. Commission amounts paid to upline users reduce the farther away a downline user is from a particular upline user. When a user associated with 456812-Point2 purchases cold medicine 456812, a user associated with 456812-Point 1 will receive a commission of $0.55. Similarly, when a user associated with pointer 456812-Point7 purchases the cold medicine, a user associated with 456812-Point6 will receive a commission of $0.55; a user associated with 456812-Point5 will receive a commission of $0.27; a user associated with 456812-Point5 will receive a commission of $0.14; a user associated with 456812-Point4 will receive a commission of $0.07; a user associated with 456812-Point3 will receive a commission of $0.03; and a user associated with 456812-Point2 will receive a commission of $0.02. Each of these commissions follow the commission decay rate of 50% beginning at a commission of $0.55 and ending at a commission of $0.02. Note that according to this commission schedule, users that are more than 5 levels away from a user a purchases cold medicine 456812 will not receive a commission for that purchase.

TABLE 5
Blockchain Database Key & Commission Data

| Pointer | Private Key | Commission Chain |
|---|---|---|
| 456812-Point1 | CB02 0301 0001 | |
| 456812-Point2 | 4003 C266 E2CD | 0.55 |
| 456812-Point3 | 2881 D673 CA2B | 0.55/0.27 |
| 456812-Point4 | C744 2654 C0DD | 0.55/0.27/0.14 |
| 456812-Point5 | 922B F01B 2F40 | 0.55/0.27/0.14/0.07 |
| 456812-Point6 | BC8F BAFA 362F | 0.55/0.27/0.14/0.07/0.03 |
| 456812-Point7 | F01B 2F40 C744 | 0.55/0.27/0.14/0.07/0.03/0.02 |

Note that the blockchain database may store numbers that specifically identify a commission paid out in a currency (i.e. dollars). Alternatively, the blockchain database may store an initial commission, a decay rate, and possibly a number of commission levels. This initial commission, decay rate, and number of commission level data may be used to calculate commissions that should be paid to specific users when a downline user purchases a product.

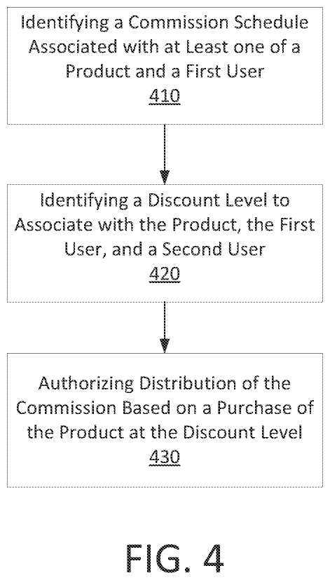

FIG. 4 illustrates a series of steps that may be performed when commissions associated with the sale of a product are identified and provided to users of a multilevel marketing organization. The steps of FIG. 1 may be performed by a computer like the administration network computer 105 of FIG. 1. FIG. 4 begins with step 410 where a commission schedule relating to the sale of a product are identified. This may include a computer accessing data stored at a third party network computer. Next in step 420, a discount level may be identified and commissions associated with the are authorized for distribution based on a purchase of the product at the discounted price.

In certain instances the administration network 105 computer may receive user data from a third party network computer 150 and the administration network computer 105 may identify whether the user data includes a code. In one instance a code may be received when a user selects or activates a hyperlink at their user device. The selection of the hyperlink may result in the code being sent from the user device to the administration network computer 105. When the received user data does include a code, that code may be extracted and data associated with the code may be looked up and accessed. In certain instances, the code may be used to identify a commission schedule as discussed above. A user device may then be directed to a third party computer based on a link included in the hyperlink as discussed in respect to FIG. 2.

An administration network computer may identify a pointer to the appropriate record in the blockchain network blockchain database for the code that was looked up at an administrations network compensation database. The pointer may direct a request for the commission data in the corresponding block. The blockchain network computer may return the calculated commission, such as $0.55 to the initial purchaser when a user in their first sphere of influence purchases cold medicine. The administration network computer may send the commission to the user (e.g., purchaser/distributor). In some instances, the administration network computer may track profits and payments as well as track taxes for users enrolled in the MLM system.

Track profits and payments may refer to the MLM system tracking the profits of the MLM and tracking the payments or commissions paid out to participants. In some instances, track taxes may refer to tracking the commissions provided to participants for tax purposes. Then, the administration network computer may compare the extracted code to data stored at an administration network hyperlink database, which may contain the list of users and the code sent to the user's followers. The administration network computer may extract the user ID and sphere of influence or potential purchaser/distributor by using the extracted. The admin network computer may compare the extracted sphere of influence or potential purchaser/distributor to the administration network compensation database. The administration computer may use the extracted sphere of influence to extract the corresponding commission from the administrations network compensation database. The administration network computer may send the commission to an upline user. If the user did not enter a code, the administration network computer may initiate operation of a set of instructions that distribute advertisements to user devices.

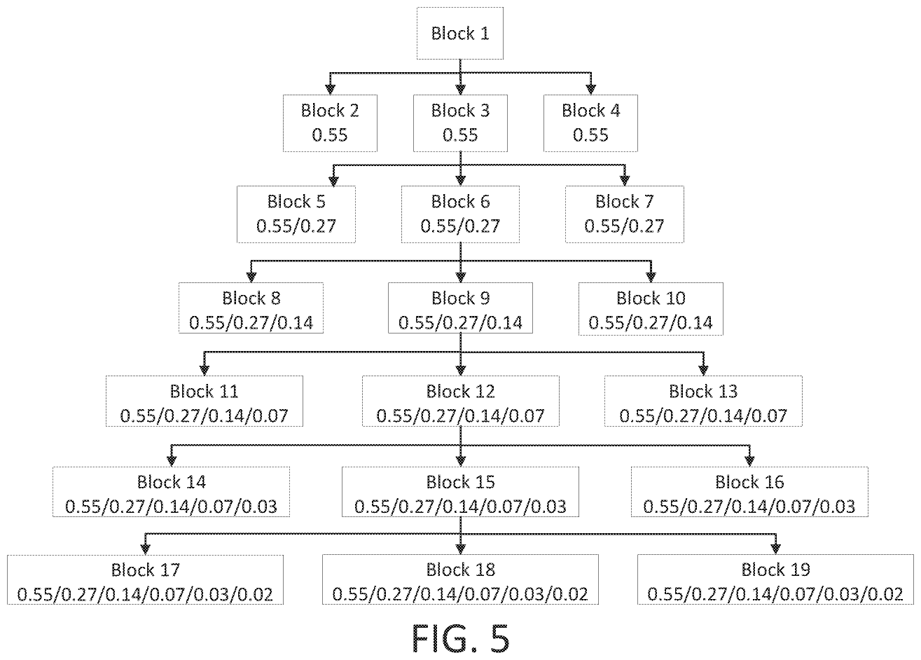

FIG. 5 illustrates respective blocks that may be used to store commission information discussed in respect to table 5 above. Note that FIG. 5 includes blocks number from block 1 to block 19 and includes several levels or tiers of blocks and related commissions. The data of table 1, table 5, and table 6 may all be identified by a third (3rd) party vendor that sells particular products via an MLM organization. Ultimately the third party that identified the data of these tables may provide funds to pay commissions after a product has been sold. In certain instances, commissions may be distributed only after a product has been received by a purchaser.

Each chain of FIG. 5 begins with a product that is being sold. A tree comes off of this initial block for each initial purchaser (someone who is participating in the MLM but not utilizing a discount or other code provided by another member) that buys that product, for example. A tree may branch off of each initial purchaser's block for each sale of the product to someone in the initial purchaser's first sphere of influence. This expanding tree of blockchains may continue as purchasers purchase products. An initial purchaser followed by a second, a third, or more users form spheres of influence of related users. Each subsequent block in the chain may store the commission data for each of the previous blocks in the chain. So the fourth sphere of influence (blocks 11-13) will have, in this example, the $0.55 commission paid to the purchaser in sphere 3 (blocks 8-10), the $0.27 paid to the purchaser in sphere 2, the $0.14 paid to the purchaser in sphere 1 (blocks 5-7), and the $0.07 paid to the initial purchaser.

While not illustrated in FIG. 5, each block of FIG. 5 may identify parent codes and child codes that may identify users associated with respective blocks in a blockchain. The different blocks included in FIG. 5 may include pointers that point to one or more next set of blocks. For example, block 1 may include a pointer that points to blocks 2, 3, and 4. Block 3 may include pointers that point to blocks 5, 6, and 7.

Each block in a blockchain database may store the public key associated with a block, which when prompted by a blockchain network computer may provide either, the ability for a third party network computer to write new product and commission structure data to the blockchain database. Commission data may be provided to an administration network computer to identify or calculate commissions that should be paid to particular users.

Referring back to the data of table 2. The data of table 2 cross-references a cold medicine (456812) with spheres of influence, pointers, and codes or links. As discussed above the codes or links of table 2 may uniquely identify specific related users (or user payment information) that purchased the cold medicine identified with identifier (ID) 456812. Here again these related users may have shared promotional materials after they purchased the cold medicine and each of these related user may have purchased the cold medicine. When a particular user of this chain of users purchases the cold medicine a pointer associated with that user may be accessed and sent to a blockchain network computer and the blockchain network computer may provide commission data to the administration computer. The blockchain computer may provide commission data to the administration computer or allow the administration computer to access relevant commission data. The administration computer may then identify commissions such that those commissions could be distributed to specific users based on the sphere of influence information and according to the commission data.

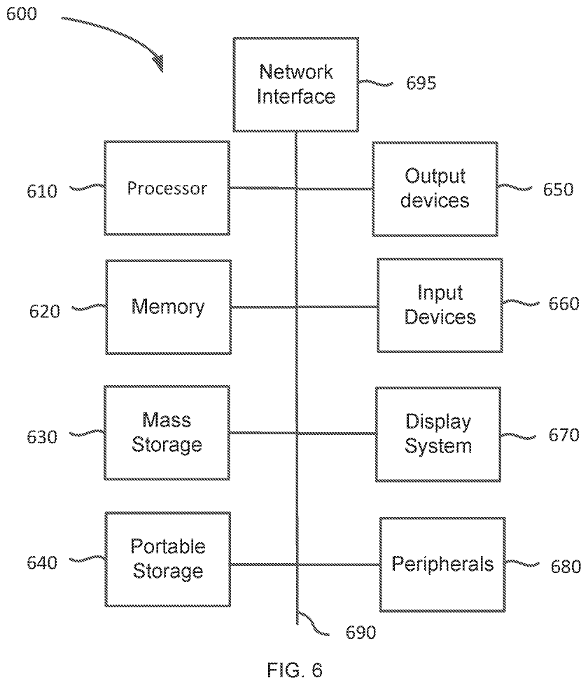

FIG. 6 illustrates a computing system that may be used to implement an embodiment of the present invention. The computing system 600 of FIG. 6 includes one or more processors 610 and main memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, peripheral devices 680, and network interface 695.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a FLASH memory, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD), a plasma display, an organic light-emitting diode (OLED) display, an electronic ink display, a projector-based display, a holographic display, or another suitable display device. Display system 670 receives textual and graphical information and processes the information for output to the display device. The display system 670 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

Network interface 695 may include any form of computer interface of a computer, whether that be a wired network or a wireless interface. As such, network interface 695 may be an Ethernet network interface, a BlueTooth™ wireless interface, an 802.11 interface, or a cellular phone interface.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 600 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

Various embodiments of the disclosure are discussed in detail above. While specific implementations are discussed, it should be understood that this is done for illustration purposes only. A person skilled in the relevant art will recognize that other components and configurations may be used without parting from the spirit and scope of the disclosure. Thus, the previous description and drawings are illustrative and are not to be construed as limiting. Numerous specific details are described to provide a thorough understanding of the disclosure. However, in certain instances, well-known or conventional details are not described in order to avoid obscuring the description. References to one or more embodiments in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described, which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure were set forth in the description, and in part are obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the appended claims or can be learned by the practice of the principles set forth herein.

What is claimed is:

1. A method for securely processing user and product data, the method comprising:
extracting extraction data from a first computing system database of a first computing system, the extraction data including at least one of product data associated with a product and first user data associated with a first user;
requesting first blockchain data stored in a first blockchain system using the extraction data and a public key, the first blockchain data associated with at least one of the product and the first user, wherein access to the first blockchain system is based on validating the public key and an associated private key;
generating a set of processed data by processing the extraction data and the first blockchain data at the first computing system;
sending the set of processed data from the first computing system to at least one of the first blockchain system, a second computing system, and a second blockchain system; and
storing the set of processed data in the first computing system database.

2. The method of claim 1, wherein the first blockchain data includes a commission schedule associated with at least one of the product and the first user, the method further comprising:
receiving at least one of the product data and the first user data at the first computing system;
determining a first discount level associated with at least one of the product, the first user, and a second user based on the product data, the first user data, and the commission schedule in the first blockchain data; and
sending the first discount level from the first computing system to at least one of the first blockchain system, a second computing system, and a second blockchain system.

3. The method of claim 1, wherein the first processed data is sent to the first blockchain system, the method further comprising:
receiving second blockchain data at the first computing system, wherein the second blockchain data is associated with the set of processed data;
comparing, at the first computing system, the set of processed data to the second blockchain data; and
generating a first consensus based on the comparison of the set of processed data and the second blockchain data, wherein the first consensus exceeds a predetermined threshold.

4. The method of claim 1, wherein the first user data includes follower data associated with a second user, the method further comprising:
generating a hyperlink, wherein a code associated with at least one of the product and the first user is embedded in the hyperlink; and
sending the hyperlink that includes the embedded code to at least one of the second computing system and a device of the second user.

5. The method of claim 4, further comprising identifying a commission associated with the first user based on use of the hyperlink that includes the embedded code and a commission schedule within the first blockchain data.

6. The method of claim 4, wherein the device of the second user uses the hyperlink to initiate a purchase of the product, and further comprising associating the purchase with a discount level associated with at least one of the product, the first user, and the second user.

7. The method of claim 4, further comprising:
tracking click-through data of the hyperlink that includes the embedded code; and
storing the tracked click-through data in the first computing system database.

8. The method of claim 1, wherein the first computing system communicates with the first blockchain system and the second computing system using a cloud network.

9. The method of claim 8, wherein the first computing system shares computing resources with the first blockchain system.

10. The method of claim 1, further comprising:
determining whether the product and the first user exist in the first computing system database based on at least one of the product data and the first user data; and
adding at least one of the product data and the first user data to the first computing system database if at least one of the product data and the first user data is not found in the first computing system database.

11. The method of claim 1, wherein at least one of the product data and the first user data includes a commission schedule, the method further comprising sending at least one of the product data and the first user data to the first blockchain system, wherein the first blockchain system:
adds at least one of the product data, the first user data, and the commission schedule to a blockchain database of the first blockchain system; and
generates the public key, the private key, and a pointer associated with the public key, wherein the pointer points to at least one of the product data, first user data, and the commission schedule stored within the blockchain database.

12. A method for securely processing user and product data, the method comprising:
generating, based on commission data, a public key, a corresponding private key, and a pointer pointing to the private key;
storing the private key and the commission data in a block at a first computing system database;
transferring the pointer and the public key to a second computing system; and
allowing the second computing system access to the commission data in the block at the first computing system database based on the use of the pointer and the public key by the second computing system.

13. The method of claim 12, wherein access to the commission data is further based on adding a second block in the first computing system, the second block associated with a sale related to the commission data.

14. The method of claim 13, further comprising assigning a commission to a user based on the sale related to the commission data.

15. The method of claim 12, wherein access to the commission data is further based on an advertisement that is sent to a plurality of user devices.

16. The method of claim 15, wherein the advertisement includes a hyperlink with an embedded code associated with the commission schedule.

17. The method of claim 16, further comprising
tracking click-through data of the hyperlink that includes the embedded code; and
storing the tracked click-through data in the first computing system database.

18. The method of claim 12, wherein access to the commission data is further based on adding a second block in the first computing system, the second block associated with new user data associated with the commission data.

19. The method of claim 18, wherein the new user data includes new product data regarding a new product, the new product data including different commission data, the method further comprising:
receiving the different commission data at a first computing system;
generating, based on the different commission data, a different public key, a different private key, and a different pointer pointing to the different private key;
storing the different private key and the different commission data in the second block at the first computing system database;
transferring the second pointer and the second public key to a third computing system; and
allowing the third computing system access to the different commission data in the first computing system database based on the different pointer and the different public key.

20. The method of claim 12, wherein the first computing system communicates with the second computing system using a cloud network.
